(19) United States
(12) Patent Application Publication
(10) Pub. No.: US 2015/0339615 A1
(43) Pub. Date: Nov. 26, 2015

(54) Systems and Methods for Providing Recognition to an Individual

(71) Applicants: Nathan Walkingshaw, Salt Lake City, UT (US); Gilbert Lee, Salt Lake City, UT (US); Bryan Bishop, Salt Lake City, UT (US)

(72) Inventors: Nathan Walkingshaw, Salt Lake City, UT (US); Gilbert Lee, Salt Lake City, UT (US); Bryan Bishop, Salt Lake City, UT (US)

(21) Appl. No.: 14/717,799

(22) Filed: May 20, 2015

Related U.S. Application Data
(60) Provisional application No. 62/000,929, filed on May 20, 2014.

(51) Int. Cl. G06Q 10/06; G06Q 40/00; G06F 3/0482; G06Q 20/34; H04L 12/58; G06F 3/0481

(52) U.S. Cl. CPC G06Q 10/06398; H04L 51/046; G06F 3/04817; G06F 3/0482; G06Q 20/342; G06Q 40/00

(57) ABSTRACT

An individual can be recognized using recognition messages. Recognition messages can be sent and received using a mobile or other computing device. These recognition messages, which can be in the form of recognition certificates, can include skill icons which identify a characteristic for which the receiving individual is being recognized. The recognition messages may also include or be linked with gift cards to show appreciation to the receiving individual. The ability for employees to include gift cards or the value of included gift cards can be controlled based on a gift card budget and privileges specified by a company.

### CROSS-REFERENCE TO RELATED APPLICATIONS

This application claims the benefit of U.S. Provisional Patent Application No. 62/000,929 which was filed on May 20, 2014.

### BACKGROUND

With the move to the digital world, people are less likely to have personal interactions. This lack of personal interaction has made it difficult to show recognition or express appreciation to another individual. Although it is possible to send an email or a text message to an individual, such messages are oftentimes inadequate for providing a desired amount of recognition or appreciation.

### BRIEF SUMMARY

The present invention extends to methods, systems, and computer program products for providing recognition to an individual. The present invention can facilitate sending and receiving recognition messages using a mobile or other computing device. These recognition messages, which can be in the form of recognition certificates, can include skill icons which identify a characteristic for which the receiving individual is being recognized. The recognition messages may also include or be linked with gift cards to show appreciation to the receiving individual. A recognition message may also include a custom or default message from the sending individual.

A recognition message may be provided to an individual electronically or in person such as by printing a recognition certificate to personally deliver to the receiving individual. When an individual elects to deliver a recognition certificate in person, an option can be provided to watch a video describing how to present the recognition certificate.

The present invention may also provide a budgeting tool that a company (or other entity) can employ to track the amount in gift cards that has been provided during a particular period of time. This budgeting tool can allow the company to provide flexibility to its employees (or other individuals) in deciding who to recognize with gift cards while preventing its employees from exceeding the budget for gift card recognitions.

The present invention may also provide a privileges tool that a company can employ to control which employees can send gift card recognitions. The privileges tool may also be employed to specify a maximum amount for the gift cards that a particular individual or group of individuals may send.

In one embodiment, the present invention is implemented as a method for sending a recognition message. Input can be received from a first individual that selects a second individual to receive a recognition message. The input can also specify one or more skills for which the second individual is being recognized. A recognition message can be generated that identifies the one or more skills. The recognition message may also include a gift card in some instances.

In another embodiment, the present invention is implemented as a method for managing the sending of recognition messages within a company. A budget tool can be displayed. The budget tool defines a budget for one or more employees of the company to include gift cards with recognition messages during a time period. An option can be provided for the one or more employees to include gift cards with recognition messages. The total value of gift cards that are included by employees in recognition message can be tracked during the time period. When the total value meets or exceeds the budget for the time period, the option can be disabled such that the one or more employees are prevented from including gift cards with recognition messages during the remainder of the time period.

In another embodiment, the present invention is implemented as a method for sending a recognition message. An option is displayed to a first individual to send a recognition message to a plurality of other individuals. A selection of a second individual to whom to send a recognition message is received from the first individual. An option to specify one or more skills for which the second individual will be recognized is displayed to the first individual. A selection of at least one of the one or more skills is received from the first individual. An option to select one or more gift cards to be provided to the second individual is displayed to the first individual. A selection of at least one of the one or more gift cards is received from the first individual. The recognition message is generated and includes an indication of the at least one selected skill and the at least one selected gift card.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIGS. 2A-2F illustrate a series of screens of a mobile application that can be displayed to assist an individual in generating a recognition message to be provided to another individual;

FIG. 3 illustrates various example skill icons that can be included in a recognition message;

FIGS. 4A and 4B illustrate an example screen of a mobile application that can be displayed to an individual to allow the individual to interact with a budget tool governing the inclusion of gift cards with recognition messages;

FIGS. 5A and 5B illustrate example screens of a mobile application that can be displayed to an individual to allow the individual to interact with a privileges tool to define how other individuals can include gift cards with recognition messages;

FIG. 6 illustrates an example screen of a mobile application that displays individuals that are followed; and

FIGS. 7A and 7B illustrate an example screen of a mobile application that displays a recognition message profile of an individual.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

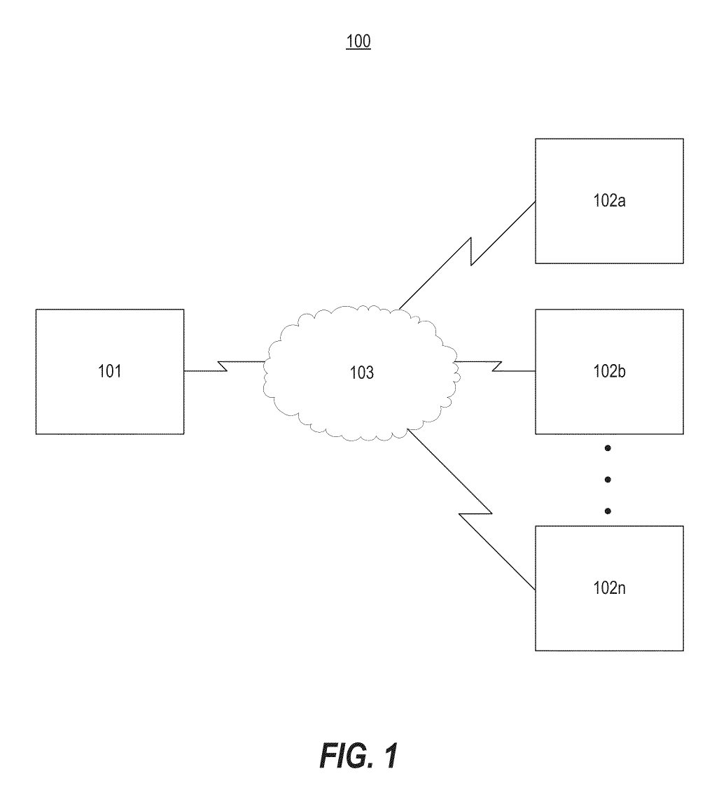

FIG. 1 illustrates an example computer environment 100 in which the present invention can be implemented. Computer environment 100 includes a server system 101, client systems 102a-102n, and a network 103 interconnecting server system 101 with client systems 102a-102n. Server system 101 can represent any number and configuration of server systems, devices, and/or components. For example, server system 101 can be a single server computing device or a cloud of server components. Similarly, client systems 102a-102n can represent the many different types of computing devices and systems that can communicate with server system 101 via network 103. For example, client systems 102a-102n may represent desktop computers, laptop computers, tablets, smart phones, etc. Network 103 can typically be the internet although other network connections, such as local connections, could also be employed.

In one example implementation, server system 101 may host various computing constructs with which mobile applications executing on client systems 102a-102n interact. For example, server system 101 may host various databases storing information that is accessed by mobile applications on client systems 102a-102n. The present invention however is not limited to mobile implementations, but can equally be implemented using desktop applications or may be a web (or browser) based implementation. Further, in addition to the client/server architecture depicted in FIG. 1, the present invention may also be implemented using a peer-to-peer architecture. Accordingly, the present invention should not be limited to any particular computing architecture or environment. For sake of clarity, the remainder of the specification will describe the present invention as being implemented using a mobile application based architecture.

According to one or more embodiments, the present invention can enable an individual to send and receive recognition messages. A recognition message is any type of message that is sent from one individual to another that recognizes the receiving individual in some manner.

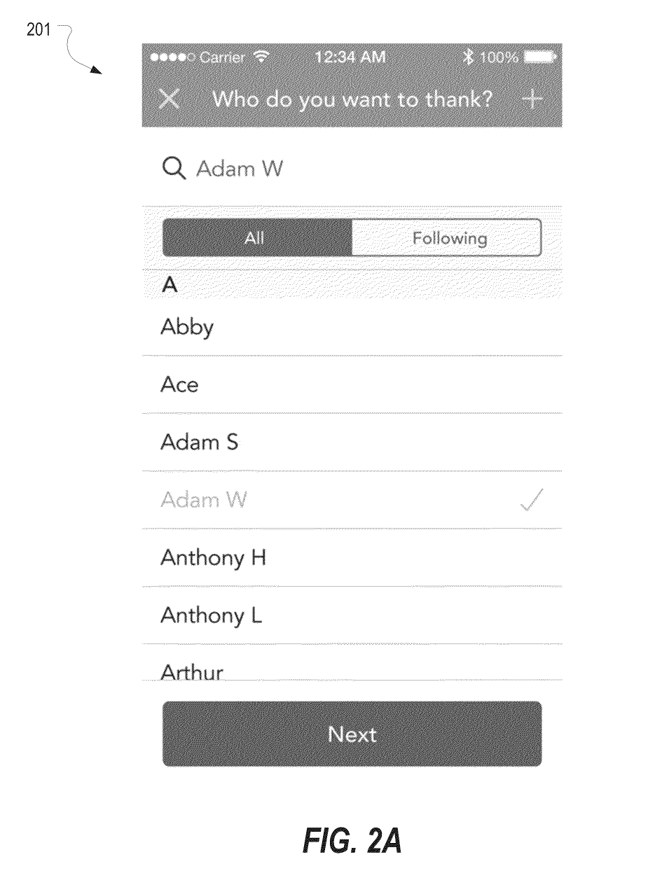

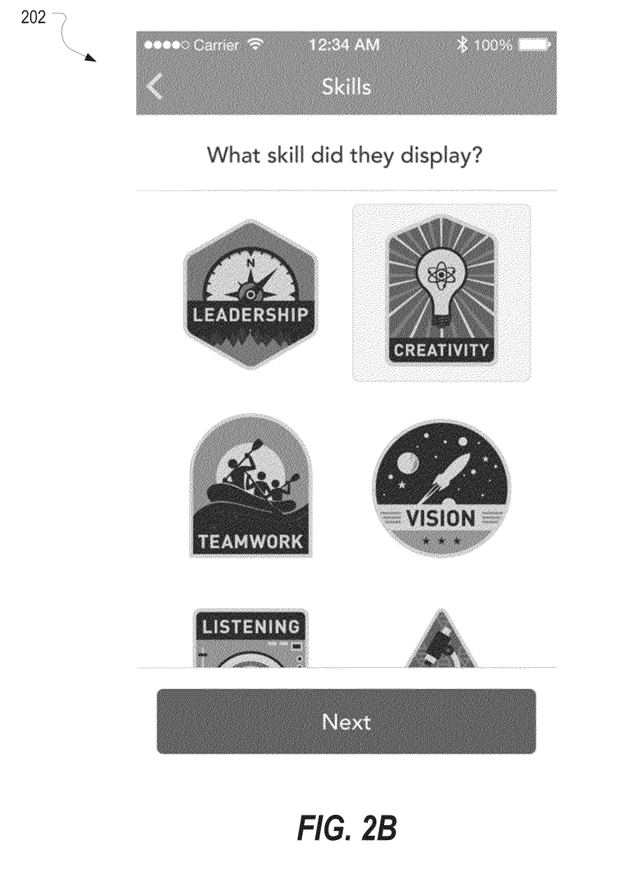

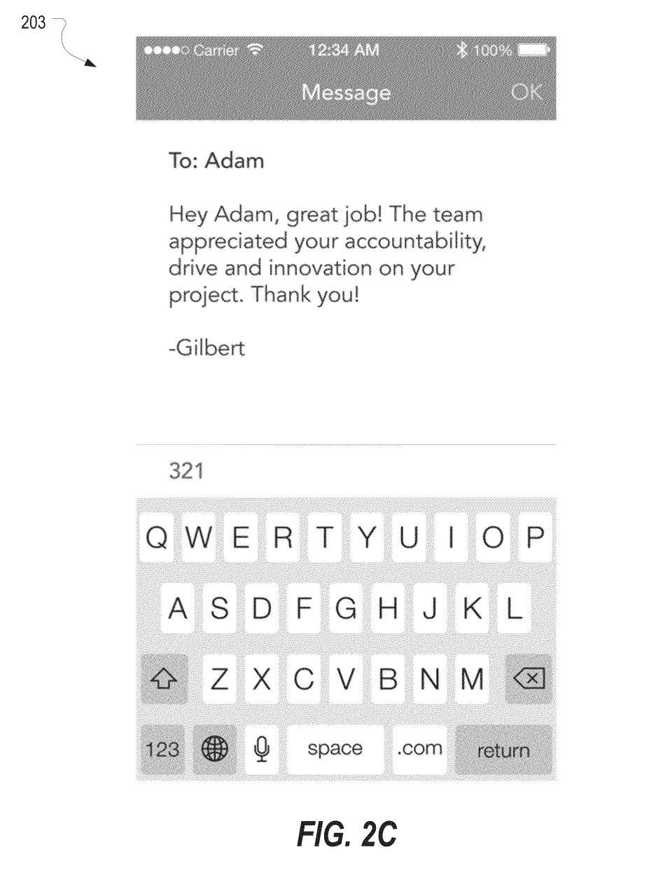

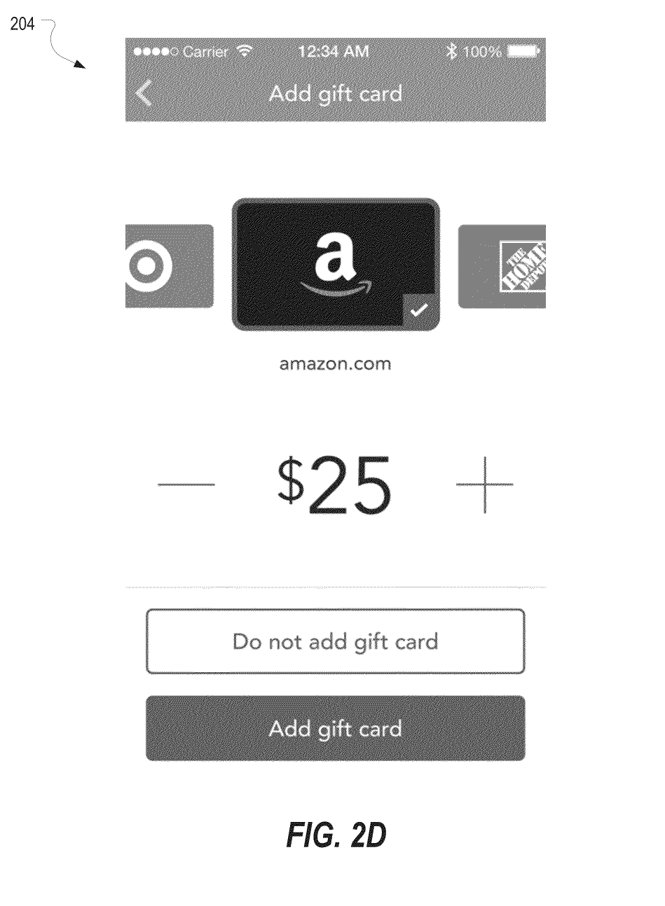

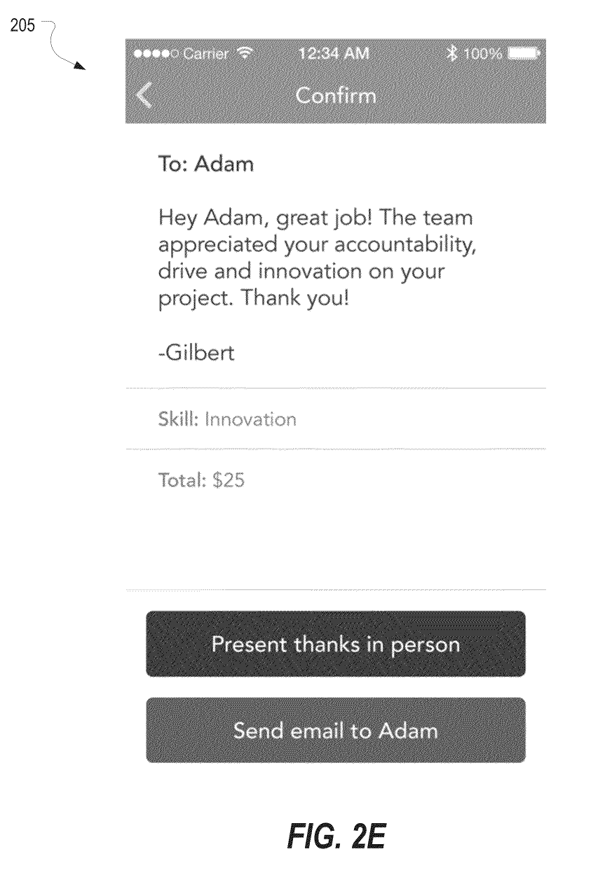

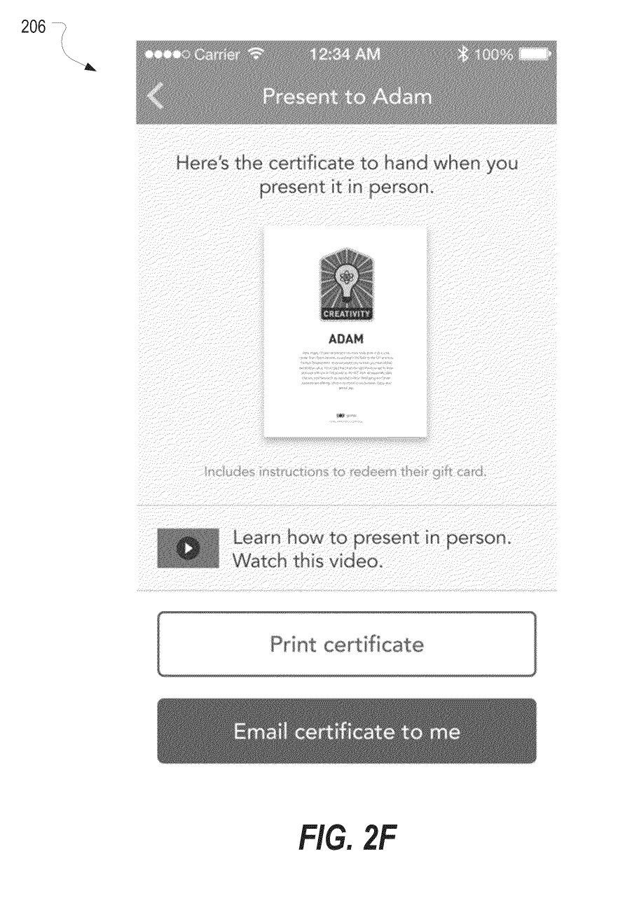

FIGS. 2A-2F illustrate a series of example screens of a mobile application that can be used to generate a recognition message in accordance with one or more embodiments of the present invention. Initially, a mobile application may display an option to send a recognition message to an individual. In this specification, recognize, thank, express appreciation, and the like are used synonymously and generally refer to the act of sending a message that acknowledges an individual in some manner.

When an individual selects the option to send a recognition message to an individual, the example screen 201 depicted in FIG. 2A can be displayed. Screen 201 can provide a list of individuals that may be selected to receive a recognition message. In FIG. 2A, screen 201 is shown as listing all individuals that may be selected, but may also include an option to list only individuals that the sending individual is following. Following an individual will be further described below. In either case, the individual may select another individual within screen 201 as the recipient for a recognition message.

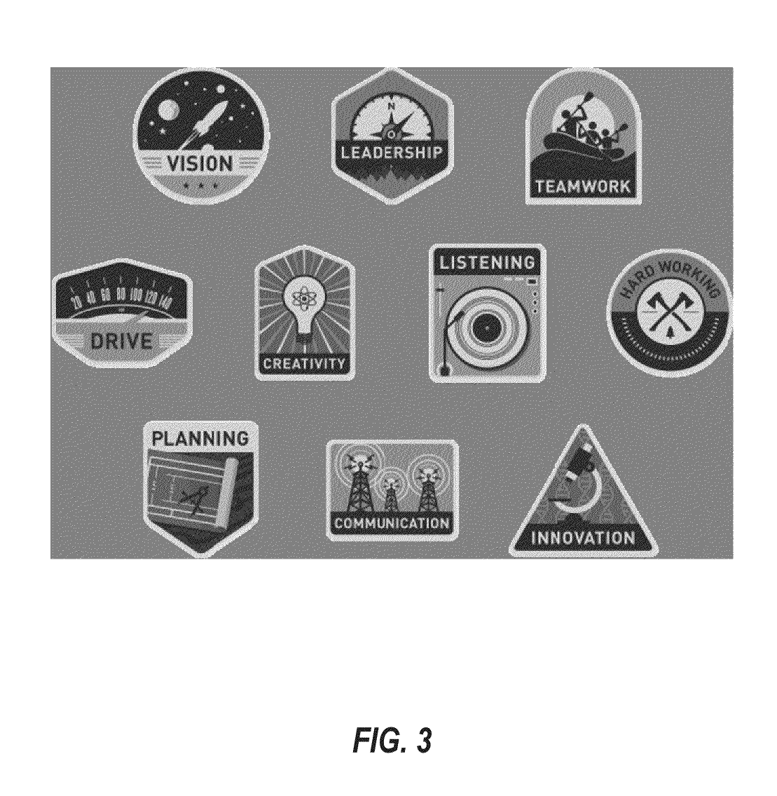

Once an individual has been selected (which in this case is Adam W as shown in FIG. 2A), screen 202 depicted in FIG. 2B may be displayed. Screen 202 presents a number of skill icons that can be selected. Each skill icon represents a characteristic for which the receiving individual can be recognized. The present invention can provide skill icons for any number of characteristics. FIG. 3, for example, illustrates example skill icons representing characteristics of Vision, Leadership, Teamwork, Drive, Creativity, Listening, Hard Working, Planning, Communication, and Innovation from which an individual may select. Screen 202 may allow the individual to select one or more skill icons to be included within the recognition message. In some embodiments, the present invention can allow a user to create custom skill icons which the user or another user may use to recognize another individual.

After the individual has selected one or more skill icons from within screen 202, screen 203 can be displayed as depicted in FIG. 2C. Screen 203 provides a text editor within which the individual (who in this case is Gilbert) may input a custom message to be included in the recognition message. Alternatively, in some embodiments, the individual may be presented with various default messages from which to select. In some embodiments, the default messages may be based on the skill icon or icons that were selected.

After the individual has provided a message, screen 204 depicted in FIG. 2D can be displayed to present the individual with the option to add a gift card to the recognition message. Screen 204 may display a number of different types of gift cards from which the individual may select. For example, as shown, the individual may select from a Target gift card, an Amazon gift card, and a Home Depot gift card. Additionally, screen 204 may provide an option to specify the value of the gift card. For example, as shown, a default value of $25 may initially be displayed along with a minus and plus sign for decreasing and increasing the value respectively. As will be further described below, the maximum value that may be specified may be limited based on the identity of the sending individual.

In some embodiments, the present invention can allow gift card companies (e.g. Target, Amazon, and Home Depot) to promote their gift cards as a default or recommended option within screen 204. For example, a company may be able to pay a fee to have its gift cards listed before the gift cards of other companies. Also, in some embodiments, screen 204 may provide an option to add other types of gifts to the recognition message. For example, screen 204 may provide an option to send flowers, tickets, or other items to the receiving individual.

After the individual has selected whether to include a gift card (or other gift) in the recognition message, screen 205 depicted in FIG. 2E can be displayed to provide a summary of the content of the recognition message and to allow the individual to confirm the content. Screen 205 may also include an option to either present the recognition message in person or to send the recognition message electronically such as by email or text message. In some embodiments, if the individual elects to send the recognition message electronically, an email, text, or similar electronic message that includes the recognition message in the form of a recognition certificate (e.g. as an attachment) may be sent. In such cases, the message provided via screen 203 may be included as part of the recognition certificate or within the body of the electronic message. In some embodiment, the present invention can provide an option for watching a video that describes how to present a recognition certificate in person.

If the individual elects to present the recognition message in person, screen 206 depicted in FIG. 2F can be displayed. Screen 206 includes a thumbnail representation of the recognition message in the form of a recognition certificate. In some embodiments, the recognition certificate can include the one or more selected skill icons, the provided message, and/or an identification of the sending individual. The recognition certificate may also include an indication of the gift card and/or instructions for redeeming the gift card. When the recognition message is sent electronically, the instructions for redeeming the gift card may alternatively be included within the body of the electronic message. If the individual has elected to present the recognition message (or certificate) in person, screen 206 can include an option for printing the recognition certificate or sending the recognition certificate to the individual for printing at a later time.

The present invention, as described above with respect to FIGS. 2A-2F, can be utilized independently by individuals or may be utilized under the direction of a company or other entity. For example, when used independently, the individual can be required to pay for the cost of including a gift card with the recognition message. However, when used under the direction of a company, the company may pay for the cost of the gift cards included by its employees. In this specification, company should be construed broadly to include any entity that includes multiple individuals under its direction whether or not it is a business entity. Employee should also be construed broadly to include any individual under the direction of or associated with a company including if the individual is an owner or manager within a company.

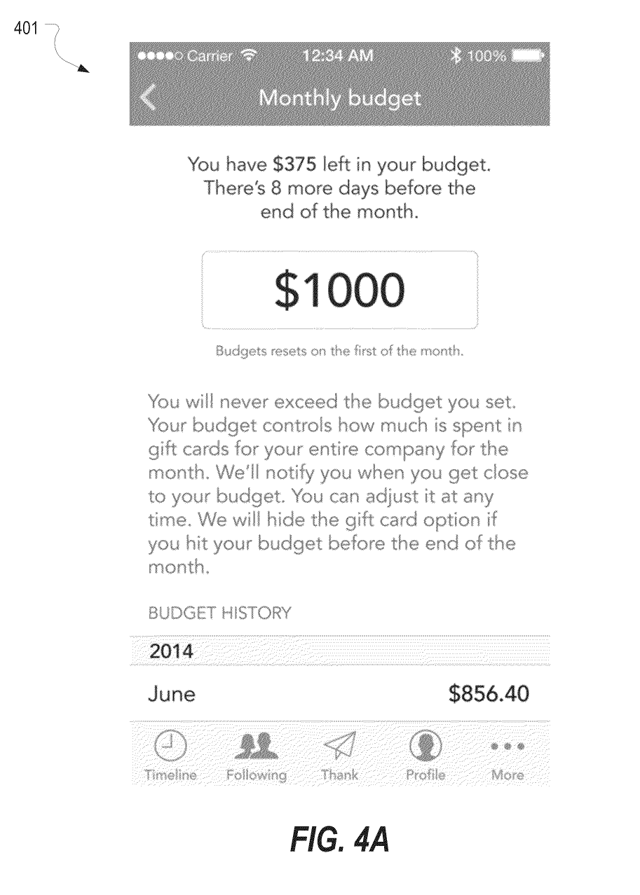

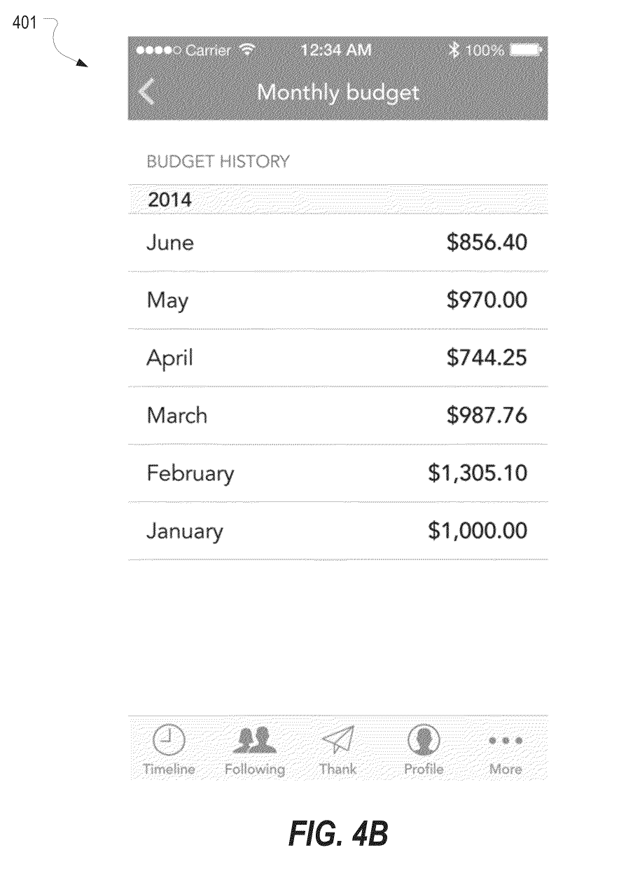

In embodiments where the present invention is used under the direction of a company, the present invention can include a budgeting tool that the company can use to control how its employees can include gift cards or other gifts with recognition messages. FIGS. 4A and 4B illustrate an example screen 401 of a mobile application that can be provided to allow a company to interact with a budgeting tool. Screen 401 lists the monthly budget that a company has set for gift cards. In this example, the monthly budget is set to $1,000 indicating that employees of the company can include gift cards up to a total value of $1,000 each month. Screen 401 can enable the company to modify this budget at any time.

Screen 401 also includes an indication of the remaining balance in the budget for the current month as well as a budget history listing the total value of gift cards that were included in previous months. FIG. 4B illustrates screen 401 once it has been scrolled down to list the budget history for each month of the current year. The budget history can therefore provide a succinct interface for identifying how much a company has spent on gift cards (or other gifts) during various time periods. In some embodiments, any remaining budget at the end of a time period can be rolled over to the next time period.

Once a company's budget has been reached during a particular time period, the present invention can prevent employees from including gift cards until the particular time period has passed. For example, instead of presenting screen 204, the present invention can display an indication that the gift card budget has been reached or may jump directly to screen 205. In this way, the employee may still send recognition messages without gift cards. Alternatively, the present invention may present the employee with the option to include a gift card if the employee pays for it. In such instances, a screen similar to screen 204 may be presented along with a notification that any included gift card must be paid for by the employee.

The present invention may also provide a privileges tool that the company may use to control which employees are allowed to include gift cards (or at least gift cards that the company will pay for). The privileges tool may also allow the company to specify the maximum amount that a particular employee or group of employees may spend on a single gift card.

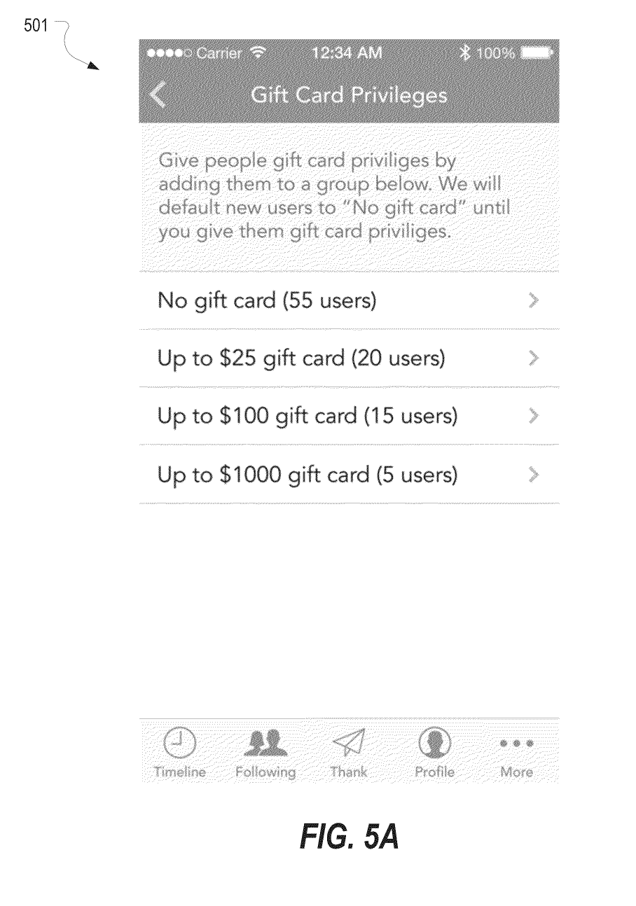

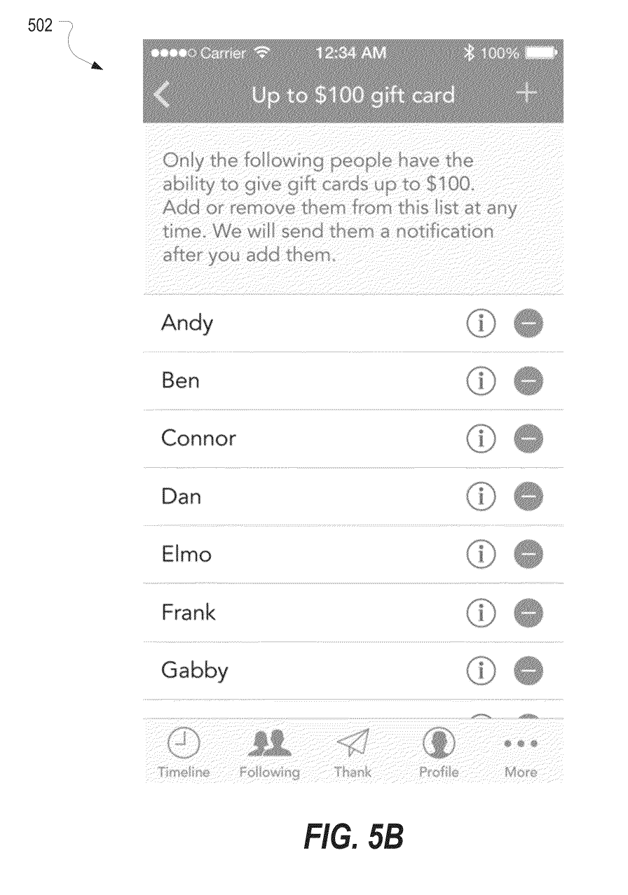

FIGS. 5A and 5B illustrate various screens that can be displayed to allow the company to specify privileges for its employees. Screen 501 depicted in FIG. 5A lists various groups where each group defines a maximum amount that members of the group may spend on an individual gift card. For example, one group may be defined for employees that do not have privileges to include gift cards with recognition messages while other groups can be defined for employees having privileges to include gift cards with values up to $25, $100, and $1000 respectively. Of course, a group can be defined for any amount.

When one of the groups is selected within screen 501, screen 502 depicted in FIG. 5B can be displayed. In this example, the $100 group has been selected. Accordingly, screen 502 displays the employees that have privileges to include gift cards having a value up to $100. Screen 502 can provide options for adding or removing employees from the group. When an employee is included in the $100 group, the present invention can customize screen 204 when displayed to an employee in the $100 group so that the maximum amount to which the value of the gift card can be increased is $100. Similarly, if an employee is in the No Gift Card group, the present invention can bypass the display of screen 204, display screen 204 with an indication that the employee must pay for any included gift card, or otherwise notify the employee that he or she does not have privileges to include gift cards.

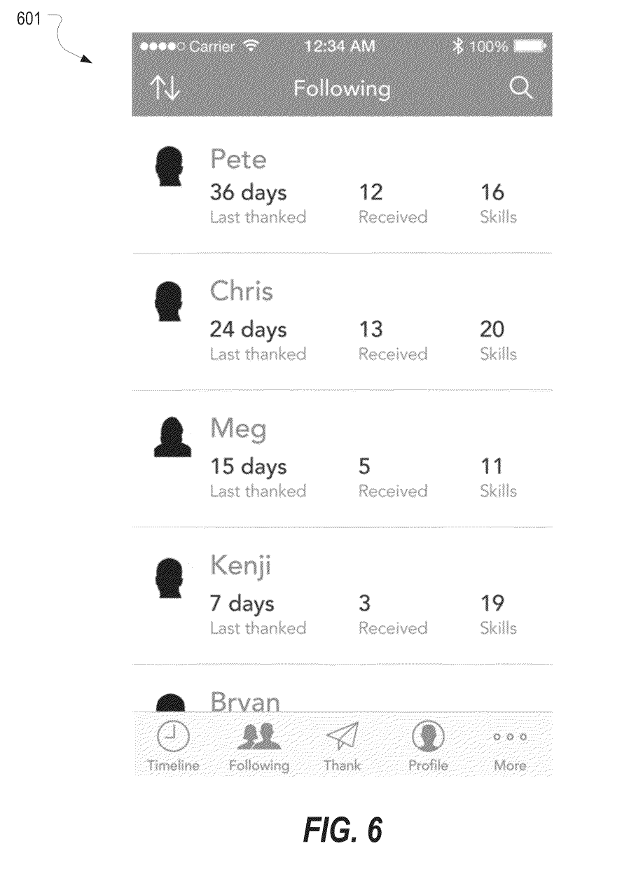

FIG. 6 illustrates an example screen 601 that lists individuals that a particular individual is following. By following an individual, the particular individual can aggregate the followed individuals into a single interface to more quickly view information about the followed individuals. As depicted in screen 601, this information can include the name of the followed individual as well as how long it has been since the followed individual received a recognition message, the total number of recognition messages the followed individual has received, and the number of skills for which the followed individual has been recognized.

In some implementations, these numbers can be based on recognition messages sent by the particular individual. For example, the 36 days since Pete was last thanked can represent when the particular individual last sent a recognition message to Pete. The ability to follow an individual can therefore facilitate tracking interactions with clients, friends, co-workers, employees, etc. For example, an individual may use the following feature to track how frequently he has sent recognition messages to members of his team or to important clients. In other implementations, these number can be based on recognition message sent by any individual. For example, the 36 days since Pete was last thanks can represent the last time any individual send a recognition message to Pete.

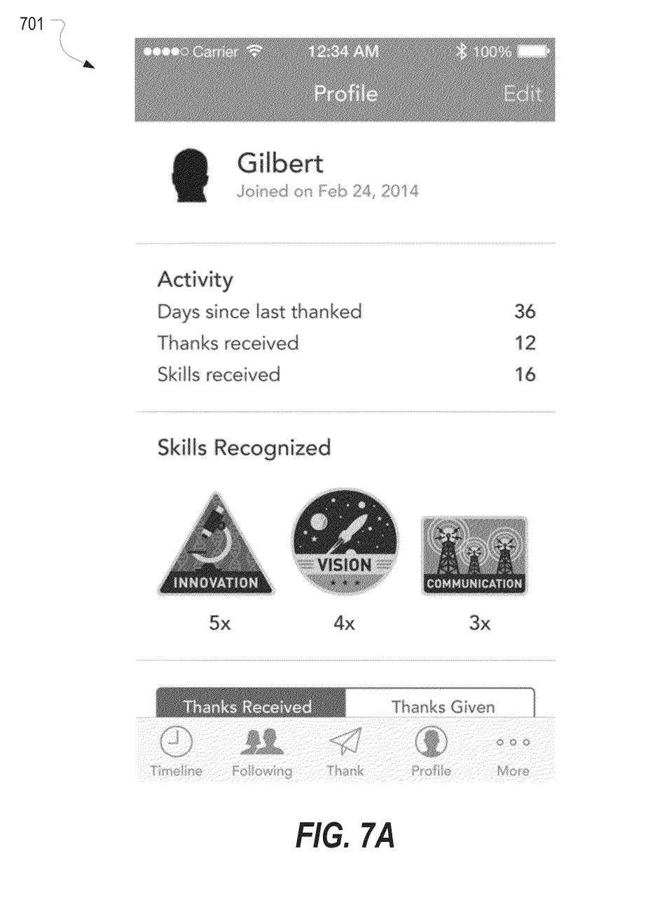

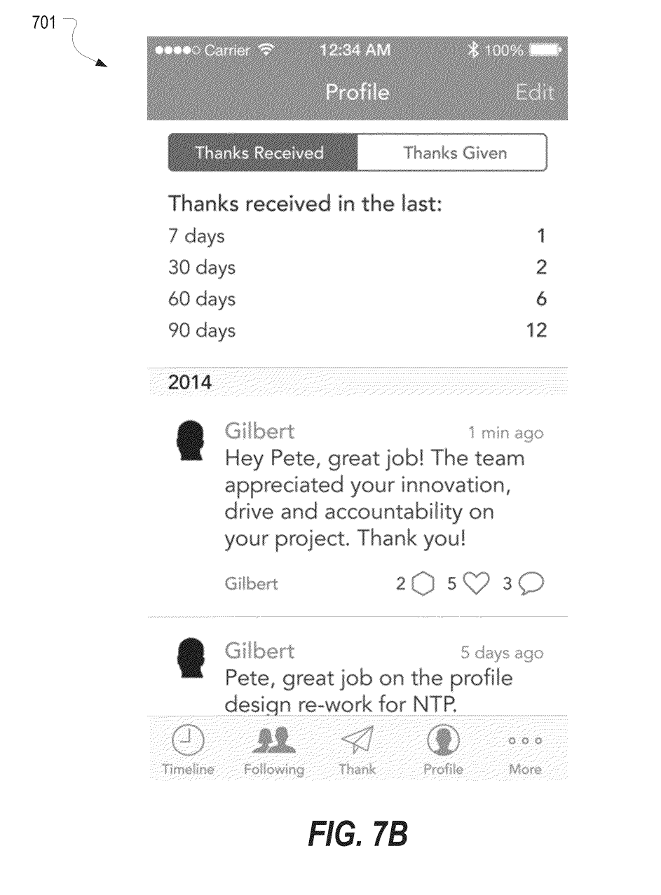

The present invention can also provide a profile for individuals or groups of individuals. FIGS. 7A and 7B illustrate an example screen 701 of a mobile application that can be used to display an individual's profile. As depicted in FIG. 7A, screen 701 provides a profile for an individual named Gilbert. The profile includes various information including when Gilbert last received a recognition message (36 days ago), the number of recognition messages received (12), the number of skills for which Gilbert has been recognized (16), and the specific skills for which Gilbert was recognized (Innovation five times, Vision four times, and Communication three times).

FIG. 7B illustrates screen 701 after it has been scrolled down. As shown, screen 701 can also include a summary of the number of recognition messages Gilbert has received during specific time periods and content of the individual recognition messages (including an indication of the number of skills recognized in the recognition message as evidenced by the hexagon in screen 701). Screen 701 also includes an option to view information about the recognition messages sent by Gilbert (by selecting the Thanks Given button). This information about recognition messages received can be similar to the information about recognition messages sent including the number of days since the last recognition message was sent, the total number of recognition messages sent, the number of skills recognized, the individuals that received a recognition message from Gilbert, etc.

In some embodiments of the present invention, a recognition message can be viewed by individuals other than the sending and receiving individuals. For example, as shown in FIG. 7B, an individual recognition message can be liked and commented on by other individuals (as evidenced by the heart and cloud shown in screen 701).

In some embodiments, the present invention can provide a dashboard for viewing statistics about recognition messages that have been sent and received within a company or other grouping. The dashboard may include a list of individuals that have received the most recognition messages, a list of individuals that have sent the most recognition messages, and/or a list of individuals that have been recognized for the most skills. Such lists can be particularly beneficial for a manager to identify which employees are performing beyond expectations or which employees possess skills that are not being fully utilized. As an example, a manager may use the dashboard to identify an individual that has received a large number of Leadership skill recognitions, but that is not in a leadership position within the company.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. One or more computer storage media storing computer executable instructions which when executed by one or more processors of a computing device implement a method for sending a recognition message, the method comprising:
receiving input from a first individual that selects a second individual to receive a recognition message, the input also specifying one or more skills for which the second individual is being recognized; and
generating a recognition message that identifies the one or more skills.

2. The computer storage media of claim 1, wherein the method further comprises:
receiving input from the first individual that specifies a message to be included in the recognition message; and
including the message in the recognition message.

3. The computer storage media of claim 1, wherein the method further comprises:
receiving input from the first individual that specifies a gift card to be included with the recognition message; and
including the gift card with the recognition message.

4. The computer storage media of claim 3, wherein receiving input from the first individual that specifies a gift card to be included with the recognition message comprises:
displaying one or more gift cards for the first individual to select;
displaying an option for the first individual to specify the value of the gift card; and
receiving input from the first individual that selects a gift card and specifies the value of the gift card.

5. The computer storage media of claim 4, wherein the option to specify the value of the gift card limits the maximum value of the gift card based on an identity of the first individual.

6. The computer storage media of claim 1, wherein the method further comprises:
selectively displaying an option to include a gift card with the recognition message based on whether a budget for including gift cards has been reached.

7. The computer storage media of claim 1, wherein the method further comprises:
selectively displaying an option to include a gift card with the recognition message based on an identity of the first individual.

8. The computer storage media of claim 1, wherein the method further comprises:
displaying a list of individuals that the first individual is following.

9. The computer storage media of claim 1, wherein the method further comprises:
displaying, to the first individual, one or more of:
an amount of time since another individual last received or sent a recognition message;
a total number of recognition messages that another individual has received or sent; or
a total number of skills for which another individual has been recognized.

10. The computer storage media of claim 1, wherein the method further comprises:
displaying, to the first individual, one or more of:
an amount of time since the first individual last received or sent a recognition message;
a total number of recognition messages that the first individual has received or sent; or
a total number of skills for which the first individual has been recognized.

11. The computer storage media of claim 1, wherein the recognition message includes one or more skill icons that identify the one or more skills.

12. The computer storage media of claim 1, further comprising:
transmitting the recognition message to a computing device of the second individual; or
enabling the first individual to print the recognition message for personal delivery to the second individual.

13. One or more computer storage media storing computer executable instructions which when executed implement a method for managing the sending of recognition messages within a company, the method comprising:
displaying a budget tool that defines a budget for one or more employees of the company to include gift cards with recognition messages during a time period;
providing an option for the one or more employees to include gift cards with recognition messages;
tracking the total value of gift cards that are included by employees in recognition message during the time period; and
when the total value meets or exceeds the budget for the time period, disabling the option such that the one or more employees are prevented from including gift cards with recognition messages during the remainder of the time period.

14. The computer storage media of claim 13, wherein, when the option is disabled, the one or more employees are enabled to send recognition messages without gift cards.

15. The computer storage media of claim 13, wherein a recognition message includes an identification of one or more skills for which a receiving individual is recognized.

16. The computer storage media of claim 13, wherein the method further comprises:
providing an option to define a maximum value for a gift card that can be included by at least one of the one or more employees.

17. The computer storage media of claim 13, wherein the method further comprises:
displaying, for at least one employee, one or more of:
an amount of time since the employee last received or sent a recognition message;
a total number of recognition messages that the employee has received or sent; or
a total number of skills for which the employee has been recognized.

18. One or more computer storage media storing computer executable instructions which when executed by one or more processors of a computing device implement a method for sending a recognition message, the method comprising:
displaying, to a first individual, an option to send a recognition message to a plurality of other individuals;
receiving, from the first individual, a selection of a second individual to whom to send a recognition message;
displaying, to the first individual, an option to specify one or more skills for which the second individual will be recognized;
receiving, from the first individual, a selection of at least one of the one or more skills;
displaying, to the first individual, an option to select one or more gift cards to be provided to the second individual;
receiving, from the first individual, a selection of at least one of the one or more gift cards; and
generating the recognition message, the recognition message including an indication of the at least one selected skill and the at least one selected gift card.

19. The computer storage media of claim 18, wherein the recognition message comprises a certificate.

20. The computer storage media of claim 18, wherein the option to select one or more gift cards includes an option to specify the value of a selected gift card that limits the maximum value based on an identity of the first individual.
